(19) United States
(12) Patent Application Publication
(10) Pub. No.: US 2026/0021936 A1
(43) Pub. Date: Jan. 22, 2026

(54) STORAGE BOX

(71) Applicant: HANGZHOU GREAT STAR INDUSTRIAL CO., LTD., Hangzhou (CN)

(72) Inventor: Wei WANG, Hangzhou (CN)

(21) Appl. No.: 19/203,223

(22) Filed: May 9, 2025

(30) Foreign Application Priority Data
Jul. 16, 2024 (CN) 202410951196.6

(51) Int. Cl. B65D 21/02; B65D 43/16

(52) U.S. Cl. CPC B65D 21/0233; B65D 43/16; B65D 2313/04

(57) ABSTRACT

A storage box. The storage box includes a box body and a box cover. The box body includes a bottom, a first frame structure and a first accommodation cavity with a first opening, and the first accommodation cavity is defined by the bottom and the first frame structure. The box cover is rotatably connected to the box body, so as to open or close the first accommodation cavity. An outline of the first opening is greater than an outline of the bottom. When the box cover is located at the first opened position, a box body of adjacent two of a plurality of the storage boxes is capable of being stacked.

### CROSS-REFERENCE TO RELATED APPLICATION

This application claims priority to Chinese patent application No. 202410951196.6, filed on Jul. 16, 2024, and titled “storage box”, the content of which is hereby incorporated by reference in its entirety.

### TECHNICAL FIELD

The present disclosure relates to the field of storage tools, in particular, to a storage box

### BACKGROUND

A permit box is generally typically hanged at construction sites, and is used to store a license file, a design drawing, etc. Typically, a bottom of the permit box is used for posting the license file and the like, and the front lower section of the permit box is provided with a baffle plate. An area behind the baffle plate is used for storing rolled-up design drawings, making it convenient for relevant departments to review. The permit box in the related art takes up a lot of space, has high transportation costs, and the baffle plate inside the permit box affects the stacking of the permit boxes.

### SUMMARY

A storage box is provided in the present disclosure. The storage box includes a box body and a box cover. The box body includes a bottom, a first frame structure and a first accommodation cavity with a first opening, and the first accommodation cavity is defined by the bottom and the first frame structure. The box cover is rotatably connected to the box body, and is capable of switching between a first opened position and a closed position so as to open or close the first accommodation cavity. An outline of the first opening is greater than an outline of the bottom. When the box cover is located at the first opened position, a box body of each of a plurality of the storage boxes is capable of being stacked.

In this way, in transport, the box cover is located at the first opened position to open the first accommodation cavity, box bodies of the plurality of storage box can be stacked together to reduce a volume occupied by the storage box. Thus, a vehicle with the same transportation space can transport more storage boxes to reduce a transportation cost of the storage box. When the storage box is being used, the storage box can be horizontally or vertically disposed.

In some embodiments, the box cover includes a top, a second frame structure and a second accommodation cavity with a second opening, the second accommodation cavity is defined by the top and the second frame structure, an outline of the second opening is greater than an outline of the top, and when the box cover is located at the first opening, a box cover of each of two storage boxes is capable of being stacked. In this way, when the storage box is in transport, the box cover is located in the opened position to open the first accommodation cavity, the box covers of the plurality of storage boxes can be stacked together, so that the box cover would not occupy a large space.

In some embodiments, the box body is provided with a baffle plate, and the baffled plate is capable of switching between a first position and a second position. When the baffle plate is located at the first position, the baffle plate is located in the first accommodation cavity, and a first region is defined between the baffle plate and the bottom. When the baffle plate is located at the second position, the baffle plate is located outside the first accommodation cavity, the box cover is located at the first opened position, and the box body of each of the plurality of storage boxes are capable of being stacked. In this way, when the baffle plate is located at the first position, objects can be stored in the first region, an the whole storage box can be horizontally disposed or vertically disposed. When the objects in the first region should be taken out, the baffle plate can be switched to the second position to give way to and expose the objects located in the first region, so as to facilitate taking out the objects. When the storage box is in transport, the baffle plate is switched to the second position to open the accommodation cavity, so that the plurality of storage boxes can be stacked together to reduce a volume occupied by the storage box, a vehicle with the same transportation space can transport more storage boxes to reduce a transportation cost of the storage box.

In some embodiments, the baffle plate is connected to a sidewall of the first frame structure and is capable of flipping relative to the sidewall of the first frame structure. Thus, the accommodation cavity has a greater exposed space for storing the objects and pasting the documents. The baffle plate is connected to the sidewall of the first frame structure, so that the baffle plate may hardly lost.

In some embodiments, the baffle plate is connected to the sidewall of the first frame structure via an axis pin.

In some embodiments, the baffle plate is connected to the sidewall of the first frame structure via a flexible member.

In some embodiments, the baffle plate is detachably connected to a sidewall of the first frame structure. Thus, the accommodation cavity has a greater exposed space for storing the objects and pasting the documents. Thus, the baffle plate can be detached from the box body according to actual needs.

In some embodiments, the baffle plate is restricted to the first position by a restricting structure, so as to prevent the objects stored in the first region from falling. In some embodiments, the restricting structure includes a first magnetic member and a second magnetic member, the first magnetic member and the second magnetic member are disposed on the first frame structure and the baffle plate, respectively, and the first magnetic member and the second magnetic member attract each other to restrict the baffle plate to the first position. The magnetic members can be disposed inside the first frame structure or inside the baffle plate, so that an external structure of the first frame structure and an external structure of the baffle plate can be neat. In some embodiments, the restricting structure includes a clipping hook and a clipping groove, the clipping hook and the clipping groove are disposed on the first frame structure and the baffle plate, respectively, and the clipping hook is clipped in the clipping groove to restrict the baffle plate to the first position. The restricting structure with such structure can form a reliable connection, and the connection is durable and hardly fails.

In some embodiments, the baffle plate is provided with at least one storage portion, so that the storage box have more functions. When the first accommodation cavity is opened, the baffle plage is disposed at an exposed position, so that common tools or other objects can be stored in the storage portion.

In some embodiments, the box cover is further provided with a second opened position, the first accommodation cavity is provided with a fulcrum bar, and the fulcrum bar is capable of switching between a storage position and a supporting position. When the fulcrum bar is located at the storage position, the fulcrum bar is accommodated in the first accommodation cavity. When the fulcrum bar is located at the supporting position, the box cover is located at the second opened position, and the fulcrum bar is configured for supporting the box cover. In this way, when the storage box is closed, that is, when the box cover is located at the closed position, and the fulcrum bar is accommodated in the first accommodation cavity to save space. When the box cover is located at the second opened position, the fulcrum bar is configured for supporting the box cover, so as to prevent the box cover from covering the box body and facilitate taking the object out or putting the object in.

In some embodiments, a bottom surface of the first accommodation cavity is provided with a display board. The display board is configured for pasting a document to facilitate reading the document.

In some embodiments, the box cover is rotatably connected to the box body via a axis pin. In this way, the box cover can be connected to the box body, and the box body can be conveniently opened or closed.

In some embodiments, one of the box cover and the box body is provided with an edgefold, the other one of the box cover and the box body is provided with a hook and the hook is capable of flipping relative to the other one of the box cover and the box body; and when the box cover close the first accommodation cavity, the hook is clipped to the edgefold.

In some embodiments, the box cover and the box body is provided with a lock. When the first accommodation cavity is closed by the box cover, the box body and the box cover are locked together by the lock. Thus, the storage box will not open due to lack of restriction, and the privacy of the objects stored in the box body can be protected.

In some embodiments, one of the box cover and the box body is provided with a groove, and the other one of the box cover and the box body is provided with a flange; and when the box cover close the first accommodation cavity, the flange is disposed in the groove to avoid mismatch between the box cover and the box body. In this way, the storage box can be tightly closed.

In some embodiments, both the groove and the flange are annular-shaped. A sealing ring is provided in the groove. When the first accommodation cavity is closed by the box cover, the leakproofness of the storage box can be ensured.

In the present disclosure, the box body includes a bottom and a first frame structure, and the bottom and the first frame structure form a first accommodation cavity. The box cover is rotatably connected to the box body to close the first accommodation cavity or open the first accommodation cavity. In addition, an outline of the first opening is greater than an outline of the bottom, and when the box cover is located at the first opened position, a box body of each of a plurality of the storage boxes is capable of being stacked. In this way, when the storage box is in transport, the box cover is located at the first opened position, so that the box bodies of the plurality of storage boxes are stacked together to reduce a volume occupied by the storage box. Thus, a vehicle with the same transportation space can transport more storage boxes to reduce a transportation cost of the storage box. When the storage box is in use, the entire storage box can be horizontally disposed or vertically disposed.

In the present disclosure, a baffle plate capable of switching between the first position and the second position. When the baffle plate is located at the first position, the baffle plate is located in the first accommodation cavity, and a first region is defined between the baffle plate and the bottom. When the baffle plate is located at the second position, the baffle plate is located outside the first accommodation cavity. Thus, when the cover plate is located at the first position, the box body of each of the plurality of storage boxes are capable of being stacked. In this way, when the baffle plate is located at the first position, objects can be stored in the first region. When the objects stored in the first region should be taken out, the position of the baffle plate can be switched to give way to and expose the objects stored in the first region. In transport, the baffle plate is switched to the second position, and the box cover is adjusted to the first opened position to open the accommodation cavity, so that the plurality of storage box can be stacked together to reduce a volume occupied by the storage box. Thus, a vehicle with the same transportation space can transport more storage boxes to reduce a transportation cost of the storage box.

Details of one or more embodiments of the present application are presented in the following accompanying drawings and description in order to make other features, purposes and advantages of the present application more concise and understandable.

### BRIEF DESCRIPTION OF THE DRAWINGS

In order to better describe and illustrate the embodiments and/or examples of the present application disclosed herein, reference may be made to one or more of the accompanying drawings. The additional details or examples used to describe the accompanying drawings should not be considered a limitation on the scope of any of the disclosed applications, the embodiments and/or examples currently described, and the best mode of these applications as currently understood.

FIG. 1 is a perspective drawing of a storage box in the present disclosure, in which the storage box is opened.

FIG. 2 is an orthographic projection figure of the opened storage box in FIG. 1.

FIG. 3 is a section view of FIG. 2 along A-A line.

FIG. 4 is a schematic diagram of two stacked storage boxes, and the storage boxes are the storage box as shown in FIG. 3.

FIG. 5 is a section view of FIG. 2 along B-B line.

FIG. 6 is a schematic diagram of two stacked storage boxes, and the storage boxes are the storage box as shown in FIG. 5.

FIG. 7 is a perspective drawing of the storage box in FIG. 1 from another angle of view.

FIG. 8 is a schematic diagram of the storage box as shown in FIG. 3, in which the storage box is closed.

FIG. 9 is a partial enlarged figure of A portion in FIG. 8.

FIG. 10 is a perspective drawing of a storage box in the present disclosure, in which a box cover is supported by the fulcrum bar.

In the figures, 100 represents a box body; 101 represents a bottom; 102 represents a first frame structure; 1021 represents a sidewall; 103 represents a first opening; 104 represents a first accommodation cavity; 105 represents a clipping groove; 106 represents an edgefold; 107 represents a flange; 108 represents a first region; 109 represents a first magnetic member; 110 represents a restricting structure; 200 represents a box cover; 201 represents a top; 202 represents a second frame structure; 203 represents a second opening; 204 represents a second accommodation cavity; 205 represents an axis pin; 206 represents a hook; 207 represents a groove; 300 represents a baffle plate; 301 represents a flexible member; 302 represents a clipping hook; 303 represents a first storage portion; 304 represents a second storage portion; 305 represents a second magnetic member; 400 represents a fulcrum bar; and 500 represents a display board.

### DETAILED DESCRIPTION

The technical solutions of the embodiments of the present application will be described in detail below with reference to the accompanying drawings. It should be noted that the embodiments described herein are merely some examples of the present application and not all possible embodiments. All other embodiments obtained by those skilled in the art without making any creative contributions based on the embodiments of the present application are within the scope of protection of the present application.

It should be noted that when a component is referred to as “provided on” another component, it can be directly provided on another component or may also exist on a centered component. When a component is considered to be “disposed on” another component, it can be directly set on another component or may also exist on a centered component. When a component is considered to be “fixed to” another component, it can be directly fixed to the other component or may also exist with an intermediate component.

Unless otherwise defined, all technical and scientific terms used in the specification of the present disclosure have the same meaning as commonly understood by those skilled in the art to which the present disclosure belongs. Terms used in the specification of the present disclosure are used only for the purpose of describing specific embodiments and are not intended to limit the present disclosure. The term “and/or” as used in the specification of the present disclosure includes any and all combinations of one or more of the relevant listed items.

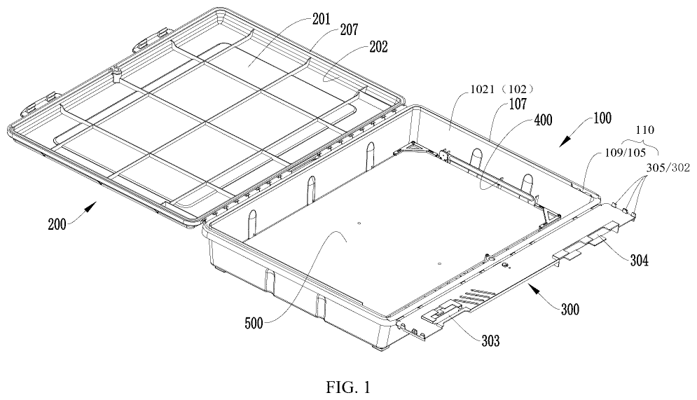

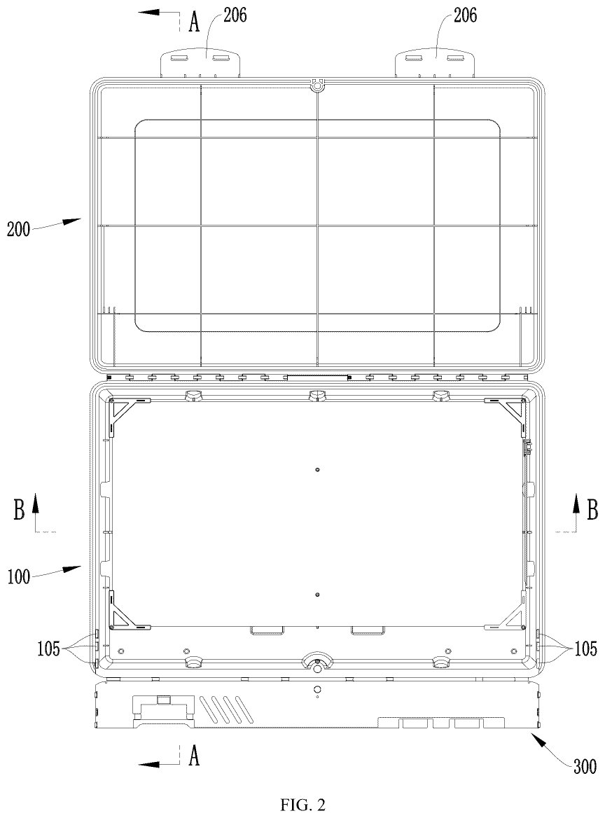

Referring to FIG. 1 to FIG. 10, a storage box is provided in the present disclosure, and the storage box in the present disclosure can be stacked together to reduce a volume of the storage box, thereby lowering the transportation cost.

The storage box includes a box body 100 and a box cover 200. The box body 100 includes a bottom 101, a first frame structure 102 and a first accommodation cavity 104 with a first opening 103, and the first accommodation cavity 104 is defined by the bottom 101 and the first frame structure 102. The first frame structure 102 is rectangular-shaped. Thus, the first frame structure 102 is provided with a sidewall 1021 at each of the four directions.

A shape of the box cover 200 fits with the shape of the box body 100. The box cover 200 is provided with a first opened position and a closed position. The box cover 200 is rotatably connected to the box body via an axis pin 201, so as to switch the box cover 200 between the first opened position and the closed position, thereby closing the first accommodation cavity 104 or opening the first accommodation cavity 104. The axis pin 205 can play a role of a hinge. In some embodiments, the box cover 200 can be rotatably connected to the box body 100 by other methods.

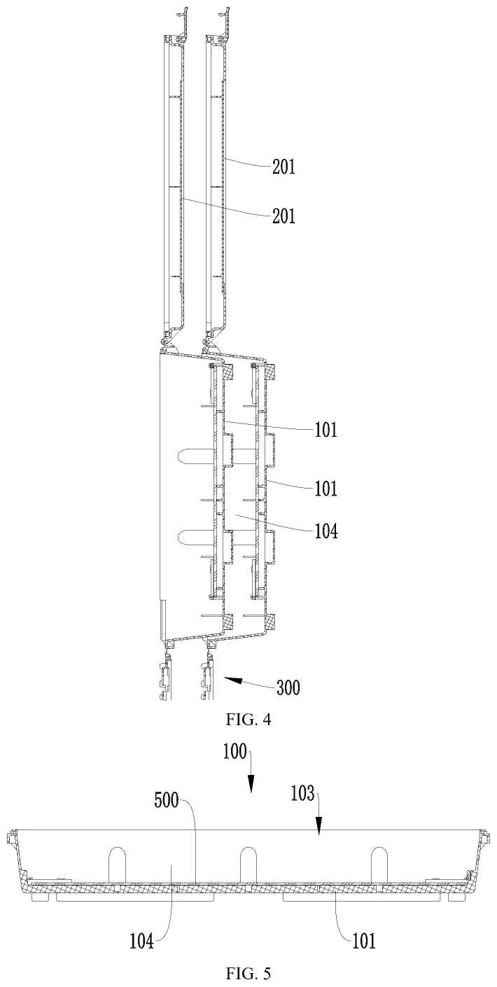

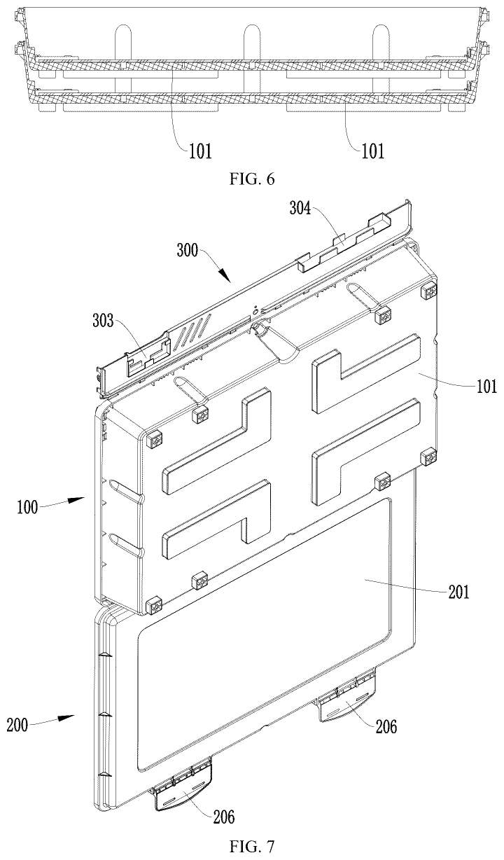

An outline of the first opening 103 is greater than an outline of the bottom 101. When the box cover 200 is located at the first opened position, a box body 100 of each of the plurality of the storage boxes is capable of being stacked. In this way, referring to FIG. 1 to FIG. 3, the storage boxes can be opened; and referring to FIG. 4 and FIG. 6, the plurality of storage boxes are stacked together to reduce the volumes occupied by the storage boxes, so as to facilitate transportation of the storage boxes.

It should be noted that “the outline of the first opening 103” refers to a size of the first opening 103 along a circumference of the first structure 102 and a shape of the first opening 103 along the circumference of the first structure 102; and “the bottom 101” refers to a size of the bottom 101 along a circumference of the first structure 102 and a shape of bottom 101 along the circumference of the first structure 102.

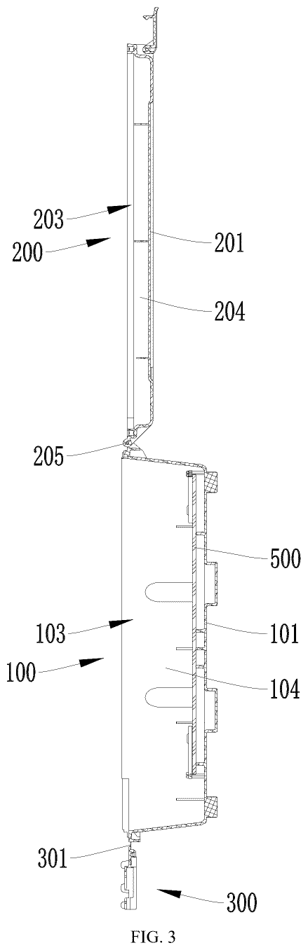

In the figures, since a size of the box cover 200 in a depth direction (i.e., a direction from the left to the right of FIG. 3 or FIG. 4) is smaller than a depth of the box body 100 in a depth direction. Thus, when the plurality of storage boxes are stacked together, a slit is left between box covers of adjacent two storage boxes of the plurality of storage boxes. Thus, stacking of the box bodies 100 will not be affected, and the box bodies 100 stacked together can be disposed as closely together as possible, so that the volume occupied by the storage boxes stacked together can be as small as possible.

It should be noted that in some embodiments, the plurality of storage boxes can be stacked together by stacking the box covers 200 of the plurality of storage boxes. In some embodiments, when the size of the box cover in the depth direction is similar to that of the box body 100 in the depth direction, the structure of the box cover 200 can be the same as that of the box body 100. That is, the box cover 200 can include a top 201, a second frame structure 202 and a second accommodation cavity 204 with a second opening 203. The second accommodation cavity 204 is defined by the top 201 and the second frame structure 202. An outline of the second opening 203 is greater than an outline of the top 201, so that box covers 200 of adjacent two storage boxes of the plurality of storage boxes can be stacked together. In this way, when the plurality of storage boxes are stacked together, box covers 200 of adjacent two storage boxes of the plurality of storage boxes are stacked together, and box bodies 200 of adjacent two storage boxes of the plurality of storage boxes are stacked together. The box cover 200 will not affect the stacking of the box body 100, and the box body 100 will not affect the stacking of the box cover 200. The box bodies 100 stacked together and/or the box cover 200 stacked together can be as tightly as possible, so that the volume of the storage box stacked together can be as small as possible.

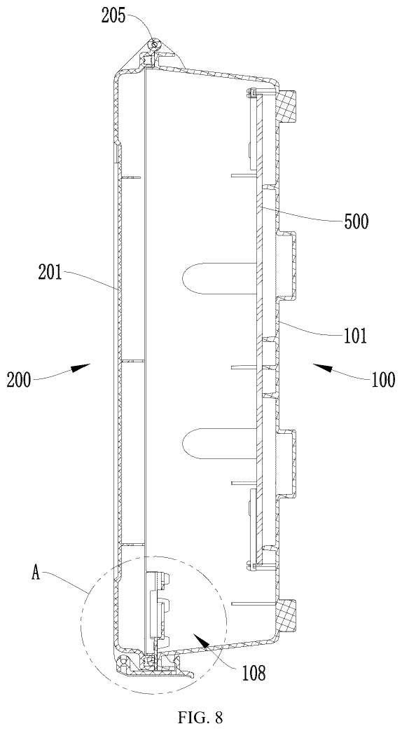

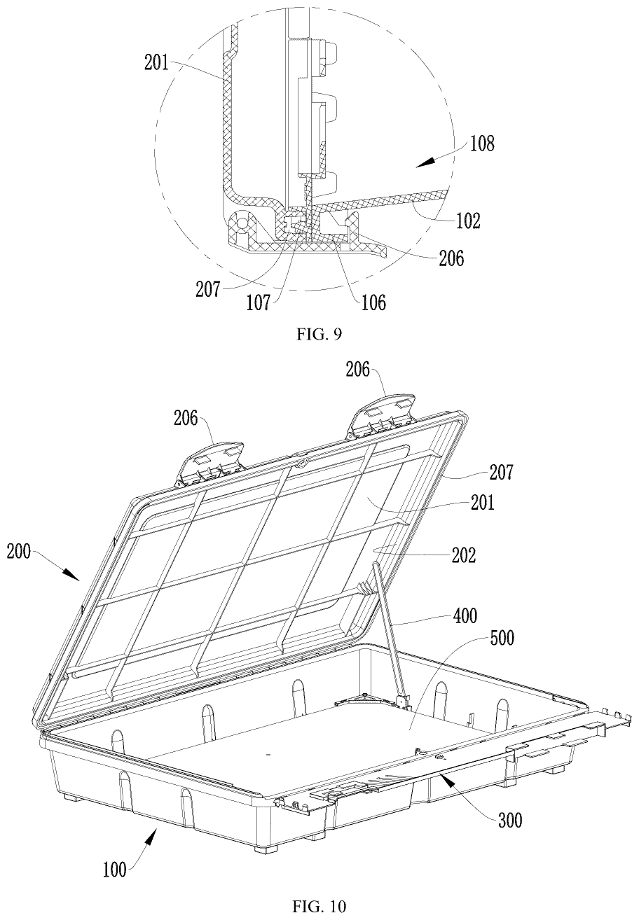

The box body 100 can be provided with a baffle plate 300, and the baffle plate 300 is capable of switching between a first position and a second position. Referring to FIG. 8 and FIG. 9, when the baffle plate 300 is located at the first position, the baffle plate 300 is located in the first accommodation cavity 104, and a first region 108 is defined between the baffle plate 300 and the bottom 101. Referring to FIG. 1 to FIG. 3, when the baffle plate 300 is located at the second position, the baffle plate 300 is located outside the first accommodation cavity 104, and the box cover 200 is located at the first opened position. Referring to FIG. 4 and FIG. 6, the box body 100 of each of the plurality of storage boxes are capable of being stacked without obstacle of the baffle plate 300.

As shown in the figures, the baffle plate 300 is rotatably connected to a sidewall 1021 of the first frame structure 102. In some embodiments, the baffle plate 300 and the box body 100 are an integral structure. The baffle plate 300 is connected to a sidewall 1021 of the first frame structure 102 via a flexible member 301. The flexible member 301 is a thin portion provided between the baffle plate 300 and the first frame structure 102, so as to facilitate rotation of the baffle plate 300. In some embodiments, the baffle plate 300 can be connected to a sidewall 1021 of the first frame structure 102 via an axis pin 205. In some embodiments, the baffle plate 300 can be detachably connected to a sidewall 1021 of the first frame structure 102.

Referring to FIG. 8 and FIG. 9, the baffle plate 300 can be restricted to the first position by a restricting structure 110. Referring to FIG. 1, the restricting structure 100 can include a clipping hook 302 and a clipping groove 105, the clipping hook 302 and the clipping groove 105 can be disposed on the first frame structure 102 and the baffle plate 300, respectively, and the clipping hook 302 can be clipped in the clipping groove 105 to restrict the baffle plate 300 to the first position as shown in FIG. 8 and FIG. 9. In some embodiments, the restricting structure 110 can include a first magnetic member 109 and a second magnetic member 305, the first magnetic member 109 and the second magnetic member 305 are disposed on the first frame structure 102 and the baffle plate 300, respectively, and the first magnetic member 109 and the second magnetic member 305 can attract each other to restrict the baffle plate 300 to the first position.

The baffle plate 300 can be provided with a first storage portion 303 and a second storage portion 304. A structure and a size of the first storage portion 303 and a structure and a size of the second storage portion 304 can be different. Thus, the first storage portion 303 as shown in the figures can be configured for storing cards, and the second storage portion 304 as shown in the figure can be configured for storing pens.

The box cover 200 can be further provided with a second opened position, the first accommodation cavity 104 can be provided with a fulcrum bar 400, and the fulcrum bar 400 can be capable of switching between a storage position and a supporting position. When the fulcrum bar 400 is located at the storage position, the fulcrum bar 400 can be accommodated in the first accommodation cavity 104. When the fulcrum bar 400 is located at the supporting position, the box cover 200 can be located at the second opened position, and the fulcrum bar 400 can be configured for supporting the box cover 200.

The bottom of the first accommodation cavity 104 can be provided with a display board 500. In actual use, related documents can be pasted on the display board 500 according to actual situations. For example, in a construction site, papers such as a certification of construction, and a license and the like can be pasted on the display board 50 for inspection.

The box cover 200 and the box body 100 can be provided with an edgefold 106 and a hook 206, respectively. Referring to FIG. 8 and FIG. 9, when the box cover 200 close the first accommodation cavity 104, the hook 206 clips the edgefold 106 to restrict the box body 100 and the box cover 200 together.

Furthermore, the box cover 200 and the box body 100 is provided with a lock. When the first accommodation cavity 104 is closed by the box cover 200, the box body 100 and the box cover 200 are locked together by the lock.

One of the box cover 200 and the box body 100 is provided with a groove 207, and the other one of the box cover 200 and the box body 100 is provided with a flange 107. Both the groove 207 and the flange 107 are annular-shaped. A sealing ring is provided in the groove 207. When the box cover 200 close the first accommodation cavity 104, the flange 107 is disposed in the groove 207 to avoid mismatch between the box cover 200 and the box body 100. In addition, the flange 107 protrudes the sealing ring to realize the sealing.

When the storage box is in operation, the storage box can be vertically disposed as shown in FIG. 8 (i.e., a bottom 101 of the box body 100 is vertically disposed), and the storage box can be fixed on a wall; optionally, the storage box can be horizontally disposed as shown in FIG. 10 (i.e., a bottom of the box body 100 is horizontally disposed).

In order to enhance the strength of the box body 100 and the box cover 200, an inner wall of the box body 100 and an inner wall of the box cover 200 can be provided with reinforcing ribs.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

1. A storage box, comprising
a box body, wherein the box body comprises a bottom, a first frame structure and a first accommodation cavity with a first opening, and the first accommodation cavity is defined by the bottom and the first frame structure; and
a box cover, wherein the box cover is rotatably connected to the box body, and is capable of switching between a first opened position and a closed position so as to open or close the first accommodation cavity;
wherein an outline of the first opening is greater than an outline of the bottom, and when the box cover is located at the first opened position, a box body of each of a plurality of the storage boxes is capable of being stacked.

2. The storage box of claim 1, wherein the box cover comprises a top, a second frame structure and a second accommodation cavity with a second opening, the second accommodation cavity is defined by the top and the second frame structure, an outline of the second opening is greater than an outline of the top, and when the box cover is located at the first opening, a box cover of each of two storage boxes is capable of being stacked.

3. The storage box of claim 1, wherein the box body is provided with a baffle plate, and the baffled plate is capable of switching between a first position and a second position;
when the baffle plate is located at the first position, the baffle plate is located in the first accommodation cavity, and a first region is defined between the baffle plate and the bottom; and when the baffle plate is located at the second position, the baffle plate is located outside the first accommodation cavity, the box cover is located at the first opened position, and the box body of each of the plurality of storage boxes are capable of being stacked.

4. The storage box of claim 3, wherein the baffle plate is connected to a sidewall of the first frame structure and is capable of flipping relative to the sidewall of the first frame structure.

5. The storage box of claim 4, wherein the baffle plate is connected to the sidewall of the first frame structure via an axis pin.

6. The storage box of claim 4, wherein the baffle plate is connected to the sidewall of the first frame structure via a flexible member.

7. The storage box of claim 3, wherein the baffle plate is detachably connected to a sidewall of the first frame structure.

8. The storage box of claim 3, wherein the baffle plate is restricted to the first position by a restricting structure.

9. The storage box of claim 8, wherein the restricting structure comprises a first magnetic member and a second magnetic member, the first magnetic member and the second magnetic member are disposed on the first frame structure and the baffle plate, respectively, and the first magnetic member and the second magnetic member attract each other to restrict the baffle plate to the first position.

10. The storage box of claim 8, wherein the restricting structure comprises a clipping hook and a clipping groove, the clipping hook and the clipping groove are disposed on the first frame structure and the baffle plate, respectively, and the clipping hook is clipped in the clipping groove to restrict the baffle plate to the first position.

11. The storage box of claim 3, wherein the baffle plate is provided with at least one storage portion.

12. The storage box of claim 1, wherein the box cover is further provided with a second opened position, the first accommodation cavity is provided with a fulcrum bar, and the fulcrum bar is capable of switching between a storage position and a supporting position. when the fulcrum bar is located at the storage position, the fulcrum bar is accommodated in the first accommodation cavity,
when the fulcrum bar is located at the supporting position, the box cover is located at the second opened position, and the fulcrum bar is configured for supporting the box cover.

13. The storage box of claim 1, wherein a bottom surface of the first accommodation cavity is provided with a display board.

14. The storage box of claim 1, wherein one of the box cover and the box body is provided with an edgefold, the other one of the box cover and the box body is provided with a hook and the hook is capable of flipping relative to the other one of the box cover and the box body; and when the box cover close the first accommodation cavity, the hook is clipped to the edgefold.

15. The storage box of claim 1, wherein one of the box cover and the box body is provided with a groove, and the other one of the box cover and the box body is provided with a flange; and when the first accommodation cavity is closed by the box cover, the flange is disposed in the groove to avoid mismatch between the box cover and the box body.
